(19) United States
(12) Patent Application Publication
(10) Pub. No.: US 2025/0243388 A1
(43) Pub. Date: Jul. 31, 2025

(54) CONDUCTIVE PASTE AND CURED PRODUCT

(71) Applicant: THREEBOND CO., LTD., Hachioji-shi, Tokyo (JP)

(72) Inventors: Satoru ENDO, Hachioji-shi, Tokyo (JP); Takashi SUZUKI, Hachioji-shi, Tokyo (JP)

(21) Appl. No.: 18/854,329

(22) PCT Filed: Apr. 11, 2023
(86) PCT No.: PCT/JP2023/014781

§ 371 Date: Oct. 4, 2024

(30) Foreign Application Priority Data
Apr. 15, 2022 (JP) 2022-067363

(51) Int. Cl. C09J 9/02; C08G 59/40; C08K 9/04; C09J 163/00

(52) U.S. Cl. CPC C09J 9/02; C08G 59/4021; C08K 9/04; C09J 163/00; C08K 2201/003; C08K 2201/006; C08K 2201/016

(57) ABSTRACT

A conductive paste contains the following components (A) to (C): component (A): an epoxy resin; component (B): a latent curing agent; and component (C): a plate-like crystalline metal powder having an average particle diameter of 0.6 to 1.4 μm. According to one embodiment of the present invention, a conductive paste can achieve both conductivity and adhesive strength in resulting cured product.

### TECHNICAL FIELD

The present invention relates to a conductive paste that achieves both conductivity and adhesive strength in resulting cured product, and to a cured product thereof.

### BACKGROUND ART

Conventionally, conductive pastes have been used for fixing and earthing (grounding) components of electric/electronic devices such as smart phones and electronic mobile devices. In recent years, there has been a demand for a low-resistant conductive paste that easily conducts electricity for grounding electronic components. In particular, there is a demand for technique for reducing not only resistance (volume resistivity) of a resin (conductive paste) itself in terms of conductivity, but also resistance (contact resistance value) between an adherend and a conductive paste. In response to such demand, it is known that resistance of a conductive paste can be reduced by using single-crystal conductive particles (for example, Japanese Patent Laid-Open No. 2016-160415 and Japanese Patent Laid-Open No. 2016-065146).

### SUMMARY OF INVENTION

However, conductive paste contains a large amount of conductive particles which are solid substances, in order to reduce contact resistance, which reduces a ratio of a resin component contained together with the particles, resulting in reducing adhesive strength.

The present invention has been made in view of the above circumstances. An object of the present invention is to provide a conductive paste that provides a cured product having an excellent balance between conductivity and adhesive strength. Another object of the present invention is to provide a cured product using the above conductive paste.

The present inventors conducted intensive studies to achieve the above objects. As a result, they found a method for obtaining a conductive paste that can achieve both conductivity and adhesive strength in resulting cured product, thereby completing the present invention.

The gist of the present invention will be described below. An embodiment of the present invention for solving the above problem relates to the following conductive paste.
[1] A conductive paste comprising the following components (A) to (C):
component (A): an epoxy resin;
component (B): a latent curing agent; and
component (C): a plate-like crystalline metal powder having an average particle diameter of 0.6 to 1.4 μm;
[2] The conductive paste according to [1], wherein a content of the component (C) is 20 to 150 parts by mass relative to 100 parts by mass of component (A);
[3] The conductive paste according to [1] or [2], wherein the component (C) has a specific surface area of 0.1 to 1.8 m²/g;
[4] The conductive paste according to any one of [1] to [3], further comprising a metal powder other than the component (C) as component (D);
[5] The conductive paste according to [4], wherein a content of the component (D) is 50 to 500 parts by mass relative to 100 parts by mass of component (A);
[6] The conductive paste according to any one of [1] to [5], wherein the component (A) contains a monofunctional epoxy resin;
[7] The conductive paste according to any one of [1] to [6], further comprising a rubber particle;
[8] The conductive paste according to [4] or [5], which is substantially composed of components (A) to (D) and at least one selected from the group consisting of a filler (preferably a rubber particle), a storage stabilizer, a metal complex and a resin;
[9] The conductive paste according to [4] or [5], which is substantially composed of components (A) to (D), and at least one selected from the group consisting of a filler (preferably a rubber particle), a storage stabilizer and a resin;
[10] The conductive paste according to [4] or [5], which is substantially composed of components (A) to (D), a filler (preferably a rubber particle), a storage stabilizer and a resin;
[11] The conductive paste according to [4] or [5], which is substantially composed of components (A) to (D), a filler (preferably rubber particles) and a storage stabilizer;
[12] A cured product of the conductive paste set forth in any one of [1] to [11].

Another aspect of the present invention for solving the above problem relates to the following conductive paste.
[1′]A conductive paste comprising the following components (A) to (C):
component (A): an epoxy resin;
component (B): a latent curing agent; and
component (C): a crystalline metal powder having an average particle diameter of 0.6 to 1.4 μm.

Preferable embodiments of the conductive pastes according to [1′] include the above embodiments of [2] to [12]. Furthermore, in the conductive pastes according to [1′], the following descriptions on each component are incorporated as the descriptions on items except for the shape of component (C).

### DESCRIPTION OF EMBODIMENTS

The present invention will be more specifically described. Note that, the present invention is not limited only to the following embodiments and can be modified in various ways within the scope of the claims. Furthermore, other embodiments can be provided by arbitrarily combining the embodiments described in the specification.

Throughout the specification, unless particularly stated otherwise, any expression in a singular form should be understood to encompass the concept of its plural form. Therefore, unless particularly stated otherwise, the article specifying a single form (for example, “a”, “an”, “the”, and the like in the case of English language) should be understood to encompass the concept of its plural form. Further, unless particularly stated otherwise, any term used in the present specification should be understood as a term that is used to have the meaning conventionally used in the relevant technical field. Therefore, unless defined otherwise, all the technical terms and scientific terms used in the present specification have the same meaning as generally understood by a person ordinarily skilled in the art to which the present invention is pertained. If there is any conflict in meaning, the present specification (including the definitions) takes priority.

In the specification, “X to Y” refers to a range including the numerical values (X and Y) described before and after thereof as the lower limit values and the upper limit values, and refers to “X or more and Y or less”. The term “(meth)acryl” in the specification refers to both of acryl and methacryl. The terms “concentration” and “%” represent mass concentration and % by mass, respectively, unless otherwise specified. The term “ratio” refers to a mass ratio unless otherwise specified. Furthermore, unless otherwise specified, operation and measurement for, e.g., physical properties, are conducted in the conditions of room temperature (20 to 25° C.) and a relative humidity of 40 to 55% RH. Furthermore, “A and/or B” means that each of A and B and a combination thereof are included.

### [Conductive Paste]

The conductive paste according to an embodiment of the present invention (hereinafter, referred to simply as the “conductive paste according to the present invention” or the “conductive paste”) contains the following components (A) to (C):
component (A): an epoxy resin;
component (B): a latent curing agent; and
component (C): a plate-like crystalline metal powder having an average particle diameter of 0.6 to 1.4 μm.

The conductive paste according to the present invention contains the above components (A) to (C). By having such a composition, a cured product resulting from the conductive paste according to the present invention is excellent in both conductivity and adhesive strength. Although the details of this mechanism are unknown, it is considered that the average particle diameter of a crystalline metal powder contained as component (C) according to the present invention is 0.6 to 1.4 μm, which allows for well-balanced improvement in conductivity and adhesive strength of a cured product. If a crystalline metal powder contained as component (C) has an average particle diameter of less than 0.6 μm, conductivity is low (see, Comparative Example 2 later described). In contrast, if the average particle diameter is more than 1.4 μm, not only conductivity but also adhesive strength of a cured product tends to be low (see, Comparative Examples 3 and 4 later described). Despite of the fact that a conductive paste containing a fine metal powder generally has a low adhesive strength, the present inventors further found that the conductive paste of the present invention containing a fine metal powder like component (C) has excellent adhesive strength. The details of the mechanism underlying such an improvement of adhesive strength are unknown, but it is considered that the effect of adhesive strength is improved as mentioned above by using a crystalline metal powder as component (C).

Note, however, the aforementioned mechanism is based on speculation, and the correctness or incorrectness of the mechanism does not affect the technical scope of the present invention.

Each component contained in the conductive paste will be described below.

### <Component (A)>

Component (A) contained in the conductive paste according to the present invention is an epoxy resin. The epoxy resin contained as component (A) is not particularly limited as long as it is a compound having 1 or more epoxy groups in one molecule. Note that, as described later in the section “(Silane Coupling Agent)”, a compound containing a silicon atom in addition to 1 or more epoxy groups is not included in component (A). For the reason that curability is excellent, it is preferable that component (A) contain a compound having 2 or more epoxy groups in one molecule (multifunctional epoxy resin). In other words, it is preferable that component (A) contain a multifunctional epoxy resin having 2 or more epoxy groups in one molecule. The upper-limit number of epoxy groups contained in one molecule of such a compound (multifunctional epoxy resin) is not limited but the number of epoxy groups is preferably 6 or less. For example, the number of epoxy groups contained in a compound contained as component (A) is preferably 2 to 6 (bi- to hexa-functional epoxy resins), more preferably 2 or 3 (bi- or tri-functional epoxy resins) and particularly preferably 2 (bifunctional epoxy resin). Note that, in a compound (epoxy resin), an epoxy group may be contained in the form of a glycidyl group.

A compound used as component (A) may be solid or liquid and is preferably liquid for the reason that it is excellent in workability. Note that, in the specification, the “liquid” refers to being a fluid state (liquid-form) at 25° C. More specifically, the “being liquid at 25° C.” refers to the state of a substance having a viscosity of 1000 Pa·s or less when the substance is measured at 25° C. by a cone-plate type rotational viscometer at a shear rate of 10 s⁻¹. Note that, in the specification, viscosity of a component means viscosity which is measured by a cone-plate type rotational viscometer at a shear rate of 10 s⁻¹. For example, viscosity of a multifunctional epoxy resin contained as component (A) at 25° C. is preferably 0.01 Pa·s or more and less than 1000 Pa·s, more preferably 0.1 to 500 Pa·s, further preferably 0.3 to 100 Pa·s, particularly preferably 0.5 to 10 Pa·s, and most preferably 0.8 to 5 Pa·s.

Epoxy equivalent of a multifunctional epoxy resin used as component (A) is not particularly limited but it is preferably 50 g/eq or more and less than 210 g/eq, more preferably, 100 g/eq or more and less than 210 g/eq and particularly preferably 130 g/eq or more and 180 g/eq or less for further improving adhesive strength. Note that, epoxy equivalent herein is a value measured in accordance with the method specified in JIS K-7236: 2001. When epoxy equivalent cannot be obtained by the method, it may be calculated by dividing molecular weight of the target epoxy resin (compound) by the number of epoxy groups contained in one molecule of the epoxy resin (compound).

Examples of the multifunctional epoxy resin used as component (A) include a bisphenol type epoxy resin; an alkylene glycol type epoxy resin; a Novolak type epoxy resin such as a phenol Novolak type epoxy resin, and a cresol Novolak type epoxy resin; a glycidylamine compound; and a naphthalene type epoxy resins having 4 glycidyl groups. These may be used alone or two types or more of them are used in combination. For the reason that conductivity is excellent, component (A) preferably contains a bisphenol type epoxy resin.

Bisphenol type epoxy resin is not particularly limited as long as it is an epoxy resin having a bisphenol skeleton. Examples of bisphenol type epoxy resin include, a bisphenol A type epoxy resin, a bisphenol F type epoxy resin, a bisphenol S type epoxy resin, a bisphenol AD type epoxy resin, a hydrogenated bisphenol A type epoxy resin, a hydrogenated bisphenol F type epoxy resin, a urethane modified bisphenol type epoxy resin, a rubber modified bisphenol type epoxy resin and a polyoxyalkylene modified bisphenol type epoxy resin. These may be used alone or two types or more of them are used in combination. For the reason that conductivity and workability are excellent, a bisphenol A type epoxy resin and a bisphenol F type epoxy resin are preferably used in combination. In other words, bisphenol type epoxy resin contained as component (A) preferably includes a bisphenol A type epoxy resin and a bisphenol F type epoxy resin. And it is more preferable that bisphenol type epoxy resin contained as component (A) is bisphenol A type epoxy resin and bisphenol F type epoxy resin.

Either a synthetic product or a commercialized product may be used as a compound (multifunctional epoxy resin) as component (A). Examples of the commercialized product of the bisphenol type epoxy resin include, but are not particularly limited to, jER (registered trademark) 828, 1001, 801, 806, 807, YX8000, YX8034 and YX4000 (manufactured by Mitsubishi Chemical Corporation), EPICLON (registered trademark) 830, 850, EXA-830CRP, EXA-830LVP, EXA-850CRP and EXA-835LV (manufactured by DIC CORPORATION), ADEKA RESIN (registered trademark) EP4100, EP4000, EP4080, EP4085, EP4088, EPU6, EPU7N, EPR4023, EPR1309 and EP4920 (manufactured by ADEKA CORP), TEPIC (registered trademark) (manufactured by Nissan Chemical Industries, Ltd.), KF-101, KF-1001, KF-105, X-22-163B and X-22-9002 (manufactured by Shin-Etsu Chemical Co., Ltd.), DENACOL (registered trademark) EX411, 314, 201, 212 and 252 (manufactured by Nagase ChemteX Corporation), DER-331, 332, 334, 431 and 542 (manufactured by Dow Chemical), and YH-434 and YH-434L (manufactured by NIPPON STEEL Chemical & Material Co., Ltd.). These may be used alone or two types or more of them are used in combination.

As component (A), a rubber-dispersed epoxy resin may be used. The rubber-dispersed epoxy resin refers to an epoxy resin having rubber particles dispersed therein. When such a rubber-dispersed epoxy resin is used, epoxy resin contained therein shall be included in the category of component (A). In other words, component (A) may contain an epoxy resin which is a resin component contained in a rubber-dispersed epoxy resin, or may be an epoxy resin which is a resin component contained in a rubber-dispersed epoxy resin.

When a rubber-dispersed epoxy resin is used as component (A), rubber particles contained in the rubber-dispersed epoxy resin may serve as a filler later described. Accordingly, component (A) having such a constitution is mixed with components (B) and (C), and component (D) and optional components to be added if necessary, which are later described, to prepare a conductive paste containing a filler. The rubber particles may be particles formed only of a single-layer structure exhibiting rubber elasticity or particles of a multilayer structure (for example, core-shell particle) having at least one layer exhibiting rubber elasticity. Rubber particles may be dispersed in an epoxy resin before use. In this case, more specifically, rubber particles may be dispersed in an epoxy resin by a mixing and stirring device such as a high-power homogenizer or synthesized within an epoxy resin by emulsion polymerization. Examples of polymer constituting rubber particles that are dispersed together with the epoxy resin as component (A) include a butadiene rubber, acrylic rubber, silicone rubber, butyl rubber, olefin rubber, styrene rubber, NBR (nitrile rubber), SBR (styrene butadiene rubber), IR (isoprene rubber) and EPR (ethylene propylene rubber). These may be used alone or two types or more of them are used in combination.

Examples of the commercialized product of the rubber-dispersed epoxy resin include KaneAce (registered trademark) MX-153, MX-136, MX-257, MX-127 and MX-451 (manufactured by KANEKA CORPORATION), and ACRYSET (registered trademark) BPF-307 and BPA-328 (manufactured by NIPPON SHOKUBAI Co., Ltd.). These may be used alone or two types or more of them are used in combination.

If a storage stabilizer contained as an optional component, which is described later, is dispersed in an epoxy resin, the epoxy resin contained therein shall be included in the category of component (A).

Component (A) preferably includes a monofunctional epoxy resin from the viewpoint of excellent workability. In other words, in a preferable embodiment, component (A) includes a monofunctional epoxy resin in addition to a compound (multifunctional epoxy resin) having 2 or more epoxy groups in one molecule, as mentioned above. The monofunctional epoxy resin is not particularly limited as long as it is a compound having a single epoxy group in one molecule. Note that, in a compound (epoxy resin), an epoxy group may be contained in the form of a glycidyl group. An addition of a monofunctional epoxy resin may adjust viscosity of component (A), furthermore a conductive paste, make it easier to prepare a conductive paste, and improve workability in using the conductive paste.

To further improve workability by adjusting viscosity of the conductive paste to be obtained, viscosity at 25° C. of a monofunctional epoxy resin used as component (A) is preferably 1 to 500 mPa·s, more preferably 3 to 100 mPa·s, and particularly preferably 5 to 50 mPa·s.

From the same viewpoint as above, epoxy equivalent of a monofunctional epoxy resin used as component (A) is preferably 100 to 500 g/eq, more preferably 150 to 350 g/eq, and most preferably 200 to 300 g/eq. By including a monofunctional epoxy resin having such an epoxy equivalent as component (A), a conductive paste having a low viscosity and excellent workability can be obtained.

Examples of the monofunctional epoxy resin include aliphatic/aromatic glycidyl ethers such as methyl glycidyl ether, ethyl glycidyl ether, n-butyl glycidyl ether, isobutyl glycidyl ether, phenyl glycidyl ether, 2-ethylhexyl glycidyl ether, decyl glycidyl ether, stearyl glycidyl ether, allyl glycidyl ether, 2-methyl octyl glycidyl ether, methoxy polyethylene glycol monoglycidyl ether, ethoxypolyethylene glycol monoglycidyl ether, butoxy polyethylene glycol monoglycidyl ether, phenoxy polyethylene glycol monoglycidyl ether, p-t-butylphenyl glycidyl ether, sec-butylphenyl glycidyl ether, n-butylphenyl glycidyl ether, phenylphenol glycidyl ether, cresyl glycidyl ether, dibromocresyl glycidyl ether, 1,4-butanediol diglycidyl ether, n-butyl glycidyl ether, allyl glycidyl ether, 2-ethylhexyl glycidyl ether, phenyl glycidyl ether, cresyl glycidyl ether, p-sec-butylphenyl glycidyl ether, t-butylphenyl glycidyl ether, diglycidyl ether, (poly)ethylene glycol glycidyl ether and butanediol glycidyl ether; aliphatic/aromatic glycidyl esters such as neodecanoic acid glycidyl ester and glycidyl methacrylate; and compounds containing a glycidyl group as a functional group such as styrene oxide. In particular, from the viewpoint of storage stability and conductivity, a monofunctional epoxy resin preferably contains at least one selected from aliphatic/aromatic glycidyl ethers and aliphatic/aromatic glycidyl esters, more preferably at least one selected from aliphatic/aromatic glycidyl esters, and particularly preferably at least one selected from aliphatic glycidyl esters. These may be used alone or two types or more of them are used in combination. In particular, for the reason that the storage stability and conductivity are excellent, neodecanoic acid glycidyl ester is preferably contained.

Either a synthetic product or a commercialized product may be used as a monofunctional epoxy resin. Examples of the commercialized product of a monofunctional epoxy resin include, but are not limited to, EPIOL (registered trademark) TB manufactured by NOF Corporation and CARDURA (registered trademark) E10P manufactured by MOMENTIVE.

In an embodiment, component (A) preferably includes a bisphenol type epoxy resin (preferably, bisphenol A type epoxy resin and bisphenol F type epoxy resin) and at least one selected from an aliphatic/aromatic glycidyl ether and aliphatic/aromatic glycidyl ester.

In an embodiment, component (A) more preferably includes a bisphenol type epoxy resin (preferably, bisphenol A type epoxy resin and bisphenol F type epoxy resin) and at least one selected from an aliphatic glycidyl ester.

In an embodiment, component (A) particularly preferably includes a bisphenol type epoxy resin (preferably, bisphenol A type epoxy resin and bisphenol F type epoxy resin) and a neodecanoic acid glycidyl ester.

When component (A) includes a monofunctional epoxy resin, a content of the monofunctional epoxy resin relative to the total content of component (A) (the total mass of component (A) is regarded as 100% by mass) is preferably 1 to 50% by mass, further preferably 5 to 40% by mass and most preferably 10 to 30% by mass. When the content is 1% by mass or more, workability and conductivity can be further improved. When the content is 50% by mass or less, a conductive paste having excellent storage stability can be obtained.

In component (A), a mass ratio of a multifunctional epoxy resin and a monofunctional epoxy resin (a mass of a multifunctional epoxy resin: a mass of a monofunctional epoxy resin) is preferably 95:5 to 50:50, more preferably 90:10 to 60:40, and particularly preferably 85:25 to 70:30.

Note that, when two types or more epoxy resins are used as component (A), the content of component (A) means the total amount thereof. Furthermore, when two types or more of multifunctional epoxy resins are used, the content of the multifunctional epoxy resin means the total amount thereof. When two types or more of monofunctional epoxy resins are used, the content of the monofunctional epoxy resins means the total amount thereof.

### <Component (B)>

Component (B) contained in the conductive paste of the present invention is a latent curing agent. A latent curing agent herein refers to a curing agent that can ensure storage stability, such as fewer changes in viscosity and physical properties over time, when dispersed in component (A).

Component (B) is not particularly limited as long as it has properties as mentioned above and can cure an epoxy resin (component (A)) but a latent thermoset curing agent (compound having thermosetting property) is preferable from the viewpoint of the balance between storage stability and curability. Examples of the latent thermoset curing agent include an imidazole compound, an adduct-type latent curing agent (a reaction product obtained by reacting an amine compound and an epoxy compound, an isocyanate compound or a urea compound), dicyandiamide, a hydrazide compound and an acid anhydride. These may be used alone or two types or more of them are used in combination. Component (B) preferably includes at least one selected from the group consisting of the compounds mentioned above. And it is more preferable that component (B) is at least one selected from the group consisting of the compounds mentioned above. In particular, from the viewpoint of the balance between storage stability and curability, component (B) preferably includes an adduct-type latent curing agent. And it is more preferable that component (B) is an adduct-type latent curing agent.

Examples of the adduct-type latent curing agent include, but are not particularly limited to, a reaction product (urea adduct-type latent curing agent) obtained by reacting an amine compound and an isocyanate compound or a urea compound and a reaction product (epoxy-amine adduct-type latent curing agent) obtained by reacting an amine compound and an epoxy compound. These may be used alone or two types or more of them are used in combination. In particular, from the viewpoint of the balance between storage stability and curability, component (B) preferably includes a urea adduct-type latent curing agent, and more preferably includes a urea adduct-type modified aliphatic polyamine latent curing agent. It is particularly preferable that component (B) is a urea adduct-type modified aliphatic polyamine latent curing agent.

Component (B) may be liquid or solid but it is preferably solid at 25° C. from the viewpoint of storage stability. Note that, in the specification, “solid” refers to a state of no fluidity at 25° C. More specifically, the “solid” refers to a substance having a viscosity of higher than 1000 Pa·s when it is measured at 25° C. by a cone-plate type rotational viscometer at a shear rate of 10 s⁻¹ or a substance having no fluidity or having extremely low fluidity such that the above-mentioned viscosity measurement cannot be performed.

Component (B) is preferably present in powder form in order to increase contact area with component (A) and the like to improve reactivity. An average particle diameter of powder is preferably 0.1 to 30 μm, more preferably 0.5 to 20 μm, particularly preferably 1 to 10 μm, and most preferably 3 to 8 μm. The average particle diameter of component (B) herein is particle diameter (D50) at a cumulative volume ratio of 50% in the particle diameter distribution obtained by the laser diffraction/scattering method.

Either a synthetic product or a commercialized product may be used as the latent curing agent as component (B). Examples of the commercialized product include, but are not particularly limited to, urea adduct-type latent curing agents such as Fujicure (registered trademark) FXE-1000, FXR-1020, FXR-1030, FXB-1050 and FXR-1081 (manufactured by T&K TOKA Corporation); and epoxy amine adduct-type latent curing agents such as AMICURE (registered trademark) PN-23, AMICURE PN-H, AMICURE PN-31, AMICURE PN-40, AMICURE PN-50, AMICURE PN-F, AMICURE PN-23J, AMICURE PN-31J, AMICURE PN-40J, AMICURE MY-24, AMICURE MY-25, AMICURE MY-R, and AMICURE PN-R (manufactured by Ajinomoto Fine-Techno Co., Inc.). These may be used alone or two types or more of them are used in combination.

A content of component (B) is preferably 1 to 100 parts by mass, further preferably 10 to 50 parts by mass and most preferably 15 to 40 parts by mass, relative to 100 parts by mass of component (A) (when two types or more compounds are used as component (A), the total amount thereof is regarded as 100 parts by mass. the same applies hereinafter). When the content of component (B) is 1 part by mass or more, a conductive paste can be excellent in curability, whereas if the content is 100 parts by mass or less, a conductive paste having excellent storage stability can be obtained. Note that, when two types or more latent curing agents are used as component (B), the content of component (B) means the total amount thereof.

### <Component (C)>

Component (C) contained in the conductive paste according to the present invention is a plate-like crystalline metal powder (hereinafter also referred to simply as “crystalline metal powder”) having an average particle diameter of 0.6 to 1.4 μm. The “crystalline metal powder” herein refers to a powder (metal powder) in which metal atoms are regularly arranged three-dimensionally.

The crystalline metal powder contained as component (C) is preferably conductive. Material of the crystalline metal powder is not limited. A crystalline metal powder can be appropriately selected from a metal particle made of at least one selected from the group consisting of metals such as gold, silver, copper, nickel, palladium, platinum, tin and bismuth; and an alloy particle made of a combination of two types or more of metals selected from the above metals; and the like. These may be used alone or two types or more of them are used in combination. In particular, from the viewpoint of conductivity and cost, the crystalline metal powder used as component (C) preferably contains a metal particle made of at least one type of metal selected from the group consisting of gold, silver, copper, nickel, palladium, platinum, tin and bismuth, and more preferably contains a silver particle. And it is particularly preferable that the crystalline metal powder used as component (C) is a silver particle.

Component (C) is preferably a single crystal. A single crystal refers to a crystal in which single types of atoms or molecules are regularly arranged in the same orientation. By using a single crystal, a conductive paste that provides a cured product with excellent conductivity can be obtained. To improve further conductivity, a crystalline metal powder as component (C) preferably contains a single crystal silver particle.

A crystalline metal powder as component (C) has a plate-like shape (plate-shaped). In the specification, “plate-like shape (plate-shaped)” refers to a shape having two smooth surfaces and a thickness (distance between the smooth surfaces) that is substantially (approximately or completely) uniform. In other words, “plate-like shape (plate-shaped)” refers to a shape in which upper and down smooth surfaces are substantially (approximately or completely) parallel. The shape and surface condition of a powder (crystalline metal powder) can be confirmed by a means routinely used such as a scanning electron microscope (SEM).

In the above, the “smooth surface” may be a surface having an arithmetic average roughness Ra of, for example, 10.0 nm or less. The arithmetic average roughness Ra of a surface of the crystalline metal powder is more preferably 8.0 nm or less and further preferably 3.5 nm or less (lower limit: 0 nm). Furthermore, the arithmetic average roughness Ra of the surface of the crystalline metal powder is preferably 1.0 nm or more. That is, a range of an arithmetic average roughness of the surface of the crystalline metal powder is preferably, for example, 1.0 to 10.0 nm, 1.0 to 8.0 nm or 1.0 to 3.5 nm, but it is not limited to these. In the specification, the arithmetic average roughness Ra of the surface of the crystalline metal powder can be evaluated by an atomic force microscope (AFM). A method for measuring the arithmetic average roughness Ra of the surface of the crystalline metal powder is, for example, disclosed in Japanese Patent Laid-Open No. 2014-196527, paragraphs “0023” to “0025” (corresponding to US Patent Application Publication No. 2016/0001362, paragraphs “0029” to “0036”). More specifically, an example of a method for measuring the arithmetic average roughness Ra of the surface of the crystalline metal powder is a method, which includes measuring the arithmetic average roughness of individual 10 particles, which are randomly selected, at a distance of 1 μm on the most planer surface (when it is difficult to measure at a distance of 1 μm on the most planer surface, at the distance as large as possible) by a scanning probe microscope SPM-9600 manufactured by Shimadzu Corporation, for example, in the following measurement conditions; calculating an average of measured arithmetic average roughness values obtained above, and taking the calculated value as an arithmetic average roughness Ra of the surfaces of the crystalline metal powder.

### <<Measurement Conditions>>

Mode: contact mode
Cantilever: OMCL-TR800PSA-1 manufactured by Olympus Corporation
Resolution: 512×512 pixels
Height-direction Resolution: 0.01 nm
Traverse direction Resolution: 0.2 nm.

Furthermore, in the above, “thickness is substantially (approximately or completely) uniform” means that the thickness varies within ±10% of the thickness of the powder (crystalline metal powder), and more preferably within ±5%. Note that, the variation in thickness is determined by measuring the thicknesses at 3 points per powder (crystalline metal powder) (one particle) by a scanning electron microscope (SEM) and calculating the average value. Furthermore, an example of the plate-like shape is a shape in which an aspect ratio (average particle diameter (D50)/average thickness (T)) described below is 3 to 100. Examples of the plate-like shape include polygonal plate shapes such as a triangular plate shape, rectangular plate shape, a pentagonal plate shape, a hexagonal plate shape and a truncated triangular plate shape.

An average particle diameter of component (C) is 0.6 to 1.4 μm, preferably 0.7 to 1.3 μm, more preferably 0.8 to 1.2 μm, and particularly preferably 0.9 to 1.1 μm. When the average particle diameter is 0.6 μm or more, a conductive paste providing a cured product excellent in conductivity can be obtained. When the average particle diameter is 1.4 μm or less, a conductive paste providing a cured product excellent in conductivity and adhesive strength can be obtained. If the average particle diameter of a crystalline metal powder corresponding to component (C) is less than 0.6 μm, the conductivity of a cured product provided by the conductive paste decreases (see, Comparative Example 2 later described). If the average particle diameter is more than 1.4 μm, not only adhesive strength but also conductivity tend to decrease (see Comparative Examples 3 and 4 later described). The average particle diameter of component (C) herein refers to the particle diameter (D50) at a cumulative volume ratio of 50% in the particle diameter distribution obtained by the laser diffraction/scattering method. The average particle diameter (D50) described in the specification can be determined by laser diffraction particle size distribution analyzer (LA-950V2) manufactured by HORIBA Ltd.

A thickness (average thickness, T) of component (C) is not particularly limited but, to further improve conductivity and adhesiveness of a cured product, it is preferably 10 to 200 nm, more preferably, 20 to 150 nm and particularly preferably 30 to 120 nm. The thickness (average thickness, T) of component (C) can be obtained by selecting 100 individual particles of a crystalline metal powder at random, measuring thicknesses of the particles, and obtaining an average value thereof. The thicknesses of the individual particles of a crystalline metal powder can be measured based on an SEM photograph.

An aspect ratio (average particle diameter (D50)/average thickness (T)) of component (C) is not particularly limited but, to further improve conductivity and adhesiveness of a cured product, the aspect ratio is preferably 5 to 100, more preferably 8 to 50, particularly preferably 10 to 35 and most preferably 15 to 30.

A specific surface area of component (C) is not particularly limited but it is preferably 0.1 to 1.8 m²/g, more preferably 0.3 to 1.6 m²/g, particularly preferably 0.5 to 1.5 m²/g and most preferably 0.8 m²/g or more and less than 1.1 m²/g. When the specific surface area is 0.1 m²/g or more, the conductivity and adhesive strength can be further improved. When the specific surface area is 1.8 m²/g or less, a conductive paste excellent in conductivity and workability can be obtained. The specific surface area herein is a value calculated by the BET method.

To improve conductivity and adhesive strength of a cured product in a well-balanced manner, in an embodiment, component (C) preferably has an average particle diameter (D50) of 0.6 to 1.4 μm and a specific surface area of 0.1 to 1.8 m²/g. In an embodiment, component (C) preferably has an average particle diameter (D50) of 0.7 to 1.3 μm and a specific surface area of 0.3 to 1.6 m²/g. In an embodiment, component (C) preferably has an average particle diameter (D50) of 0.8 to 1.2 μm and a specific surface area of 0.5 to 1.5 m²/g. In an embodiment, component (C) preferably has an average particle diameter (D50) of 0.9 to 1.1 μm and a specific surface area of 0.8 m²/g or more and less than 1.1 m²/g.

Furthermore, a surface of a crystalline metal powder as component (C) may be treated with a lubricant (surface treatment). As the lubricant, a saturated fatty acid and/or an unsaturated fatty acid can be used. Examples of the lubricant include caproic acid (hexanoic acid), capric acid, undecylic acid, lauric acid, tridecylic acid, myristic acid, pentadecylic acid, palmitic acid, margaric acid, stearic acid, linolenic acid, linoleic acid, palmitoleic acid and oleic acid. In particular, in view of excellent in dispersibility and storage stability, the lubricant preferably contains a saturated fatty acid, more preferably contains at least one selected from the group consisting of caproic acid, lauric acid, palmitic acid and stearic acid, and particularly preferably contains stearic acid. Most preferably, the lubricant is stearic acid. These may be used alone or two types or more of them are used in combination.

Either a synthetic product or a commercialized product may be used as a crystalline metal powder as component (C). Component (C) can be produced by a commonly known method, for example, disclosed in Japanese Patent Laid-Open No. 2014-196527 (corresponding to US Patent Application Publication No. 2016/0001362).

Commercialized product of component (C) is not particularly limited, for example, LM1 (manufactured by Tokusen Kogyo Co., Ltd.) is mentioned.

A content of component (C) is preferably 10 to 500 parts by mass, more preferably 20 to 300 parts by mass, more preferably 20 to 200 parts by mass, further preferably 20 to 150 parts by mass, further more preferably 30 to 100 parts by mass, particularly preferably 50 to 100 parts by mass, and most preferably 70 to 90 parts by mass, relative to 100 parts by mass of component (A). When the content of component (C) is 10 parts by mass or more, the conductivity and adhesive strength of a cured product can be further improved. When the content of component (C) is 500 parts by mass or less, a conductive paste excellent in workability can be obtained. Note that, when two types or more crystalline metal powders are used as component (C), the content of component (C) means the total amount thereof.

### <Component (D)>

The conductive paste according to the present invention may further contain a metal powder other than component (C), as component (D). The conductivity can be further improved when component (D) is used in combination with component (C) according to the present invention.

Material of a metal powder as component (D) is not limited. The metal powder can be appropriately selected from a metal particle made of at least one selected from the group consisting of metals such as gold, silver, copper, nickel, palladium, platinum, tin and bismuth; and an alloy particle made of a combination of two types or more of metals selected from the above group of metals; a particle surface-coated with aforementioned metal as a coating layer (a particle having a coating layer of at least one type of metal selected from the above group of metals). These may be used alone or two types or more of them are used in combination.

From the viewpoint of conductivity and cost, component (D) preferably contains a metal particle made of at least one metal selected from the group consisting of gold, silver, copper, nickel, palladium, platinum, tin and bismuth and/or a particle having a coating layer made of at least one metal selected from the group consisting of gold, silver, copper, nickel, palladium, platinum, tin and bismuth; more preferably contains a silver particle and/or a particle coated with silver (particle having a coating layer made of silver), further preferably contains a silver particle and a particle coated with silver (particle having a coating layer made of silver). And it is particularly preferable that component (D) is a silver particle and a particle coated with silver (particle having a coating layer made of silver). A mass ratio of a silver particle and a particle coated with silver (silver particle mass: silver-coated particle mass) is preferably 90:10 to 30:70, more preferably 80:20 to 40:60, further preferably 70:30 to 50:50, particularly preferably 60:40 to 50:50 and most preferably 55:45 to 50:50.

Examples of shape of component (D) include spherical (e.g., perfectly spherical), irregular, flake-shaped (scale-like), filament-like (needle-like), and dendrite-like shape. In particular, to improve conductivity by increasing a specific surface area, shape of a metal powder as component (D) is preferably a spherical (particularly, perfectly spherical) or flake-shaped (scale-like) shape. In an embodiment, it is preferable that a silver particle as component (D) has a flake-like shape, and a particle coated with silver as component (D) has a spherical (preferably perfectly spherical) shape.

Furthermore, it is preferable that component (D) is non-crystalline. In other words, component (D) is preferably a non-crystalline metal powder. The “non-crystalline metal powder” herein refers to a metal powder except for the above “crystalline metal powder”. Furthermore, a surface of the metal powder as component (D) may be treated with a lubricant (surface treatment). As the lubricant, a saturated fatty acid and/or an unsaturated fatty acid can be used. Examples of the lubricant include caproic acid (hexanoic acid), capric acid, undecylic acid, lauric acid, tridecylic acid, myristic acid, pentadecylic acid, palmitic acid, margaric acid, stearic acid, linolenic acid, linoleic acid, palmitoleic acid and oleic acid. In view of excellent in dispersibility and storage stability, the lubricant preferably contains a saturated fatty acid, more preferably contains at least one selected from the group consisting of caproic acid, lauric acid, palmitic acid and stearic acid, and particularly preferably contains stearic acid. And it is most preferable that the lubricant is stearic acid. These may be used alone or two types or more of them are used in combination.

In an embodiment, an average particle diameter of component (D) is preferably 0.1 to 30 μm, more preferably 0.5 to 10 μm, and particularly preferably 1.5 to 5 μm. In another embodiment, an average particle diameter of component (D) is preferably 0.1 μm or more and less than 0.6 μm or more than 1.4 μm and 30 μm or less, more preferably more than 1.4 μm and 20 μm or less, still further preferably 1.5 to 10 μm, and particularly preferably 1.5 to 4 μm. The average particle diameter of component (D) herein is the particle diameter (D50) at a cumulative volume ratio of 50% in the particle diameter distribution obtained by the laser diffraction/scattering method.

Examples of a commercialized product of component (D) include Silbest (registered trademark) TC-770 (manufactured by Tokuriki Honten Co., Ltd.).

A content of component (D) is preferably 50 to 500 parts by mass, more preferably 100 to 400 parts by mass, further preferably 130 to 300 parts by mass, particularly preferably 150 to 200 parts by mass, and most preferably 150 to 180 parts by mass, relative to 100 parts by mass of component (A). In another embodiment, a content of component (D) is particularly preferably 135 to 200 parts by mass, and most preferably 140 to 180 parts by mass, relative to 100 parts by mass of component (A). When the content of component (D) is 50 parts by mass or more, the conductivity can be further improved. When the content of component (D) is 500 parts by mass or less, a conductive paste excellent in workability can be obtained. Note that, when two types or more of metal powders are used as component (D), the content of component (D) means the total amount thereof.

A mass ratio of component (C) and component (D) (component (C) mass: component (D) mass) is preferably 5:95 to 80:20, more preferably 10:90 to 60:40, furthermore preferably 15:85 to 50:50, particularly preferably 20:80 to 45:55 and most preferably 30:70 to 40:60 for the reason that a conductive paste providing a cured product excellent in conductivity can be obtained.

A total content of component (C) and component (D) relative to the whole conductive paste (total mass of the conductive paste is regarded as 100% by mass) is preferably 40 to 90% by mass, further preferably 50 to 80% by mass and particularly preferably 55 to 75% by mass. When the total content of component (C) and component (D) is 40% by mass or more, the conductivity of a cured product can be further improved, and when the total content of component (C) and component (D) is 90% by mass or less, a conductive paste excellent in workability can be obtained.

A content of component (D) relative to 100 parts by mass of the total of components (A) to (C) (the total of components (A) to (C) is regarded as 100 parts by mass) is preferably 40 to 300 parts by mass, further more preferably 45 to 200 parts by mass, further preferably 50 to 150 parts by mass, particularly preferably 60 to 100 parts by mass, and most preferably 70 to 90 parts by mass. When the content of component (D) relative to 100 parts by mass of the total of components (A) to (C) is 40 parts by mass or more, the conductivity of a cured product can be further improved, and when the content of component (D) is 300 parts by mass or less, a conductive paste excellent in workability can be obtained.

### <Organic Solvent>

The conductive paste according to the present invention preferably contains substantially no organic solvents and more preferably contains no organic solvents (content: 0% by mass). The “contains substantially no organic solvents” represents that the addition amount (content) of an organic solvent relative to the total mass of a conductive paste is less than 0.1% by mass. If a conductive paste contains an organic solvent, the organic solvent may dissolve component (B), resulting in a decrease in storage stability and separation of the organic solvent, which may affect physical properties. When an organic solvent is contained, a content of the organic solvent relative to the whole conductive paste (the total mass of the conductive paste is regarded as 100% by mass) is preferably 1% by mass or less, more preferably 0.5% by mass or less and most preferably 0.1% by mass or less (lower limit: 0% by mass). When the content of the organic solvent is 1% by mass or less, deterioration of storage stability and separation of the organic solvent can be effectively suppressed.

Examples of the organic solvent include aromatic organic solvents such as toluene and xylene; aliphatic hydrocarbon organic solvents such as n-hexane; alicyclic hydrocarbon organic solvents such as cyclohexane, methylcyclohexane and ethylcyclohexane; ketone organic solvents such as acetone and methyl ethyl ketone; alcohol organic solvents such as methanol and ethanol; ester organic solvents such as ethyl acetate and butyl acetate; and propylene glycol ether organic solvents such as propylene glycol methyl ether, propylene glycol ethyl ether, and propylene glycol-t-butyl ether. In an embodiment, the conductive paste according to the present invention preferably contains substantially an organic solvents as mentioned above and more preferably contains no organic solvents (content: 0% by mass).

### <Optional Components>

The conductive paste according to the present invention may contain various additives as optional components as needed in addition to the components mentioned above as long as the effects of the present invention are not impaired. Examples of the additives include a silane coupling agent, a plasticizer, a filler (excluding components (C), (D)), a storage stabilizer, a tackifier, a metal complex (preferably organometallic complex), a resin (excluding component (A)), an organic or inorganic pigment, a rust inhibitor, an antifoaming agent, a dispersant, a surfactant, a viscoelasticity adjuster and a thickener. In particular, as the optional component, at least one selected from the group consisting of a silane coupling agent, a filler, a storage stabilizer, a metal complex (preferably organometallic complex) and a resin is preferably contained; at least one selected from the group consisting of a filler, a storage stabilizer, a metal complex (preferably organometallic complex) and a resin is more preferably contained; at least two selected from the group consisting of a filler, a storage stabilizer, a metal complex (preferably an organometallic complex) and a resin is further more preferably contained; at least one selected from the group consisting of a filler, a storage stabilizer and a resin is further more preferably contained; a filler and a storage stabilizer is particularly preferably contained, and a filler, a storage stabilizer and a resin is most preferably contained.

### (Silane Coupling Agent)

The conductive paste according to the present invention may contain a silane coupling agent. Examples of the silane coupling agent include glycidyl group-containing silane coupling agents such as 3-glycidoxypropyltriethoxysilane, 3-glycidoxypropylmethyldimethoxysilane, 3-glycidoxypropyltrimethoxysilane and 3-glycidoxypropylmethyldiethoxysilane; vinyl group-containing silane coupling agents such as vinyltris(β-methoxyethoxy) silane, vinyltriethoxysilane and vinyltrimethoxysilane; (meth)acrylic group-containing silane coupling agents such as γ-methacryloxypropyltrimethoxysilan; amino group-containing silane coupling agents such as N-β-(aminoethyl)-γ-aminopropyltrimethoxysilane, γ-aminopropyltriethoxysilane, and N-phenyl-γ-aminopropyltrimethoxysilane; γ-mercaptopropyltrimethoxysilane, γ-chloropropyltrimethoxysilane, and oligomers of these. In view of excellent adhesiveness, a glycidyl group-containing silane coupling agent is preferable. Note that, a glycidyl group-containing silane coupling agent (more specifically, a compound containing an epoxy group and a silicon atom) is not included in component (A) of the present invention and is treated as a silane coupling agent (more specifically, optional component). These may be used alone or two types or more of them are used in combination.

Examples of a commercialized product of a silane coupling agent include, but are not particularly limited to, KBM-1003, KBE-1003, KBM-303, KBM-403, KBE-403, KBM-502, KBE-502, KBM-503, KBE-503, KBM-5103, KBM-1403, KBM-602, KBM-603, KBM-903 and KBE-903 (manufactured by Shin-Etsu Chemical Co., Ltd.), Z-6610, Z-6044, Z-6825, Z-6033, and Z-6062 (manufactured by Dow Corning Toray Co., Ltd.).

### (Filler)

The conductive paste according to the present invention may contain a filler except for component (C) and component (D). Examples of the filler include glass, silica, talc, mica, ceramics, calcium carbonate, carbon powder, kaolin clay, dried clay mineral, dried diatomaceous earth, and a rubber particle. For the reason that a decrease of conductivity of a cured product can be effectively suppressed, a rubber particle is preferably used as the filler. In other words, the conductive paste according to the present invention preferably further contains a rubber particle in addition to components (A) to (C), and component (D) to be added if necessary.

In the specification, the “rubber particle” refers to a particle having a layer exhibiting rubber elasticity. A rubber particle may be a particle only made of a single layer exhibiting rubber elasticity or a core-shell particle of a multilayer structure having at least one layer exhibiting rubber elasticity. Although the reason is unclear, from the viewpoint of excellent resin resistance (also referred to as volume resistivity), it is preferable that a rubber particle as a filler is a core-shell particle. Also, a rubber particle dispersed in advance in an epoxy resin (epoxy resin contained as component (A)) may be used. Here, a method for dispersing a rubber particle in an epoxy resin is the same as explained in the above section <Component (A)>. Examples of a polymer constituting a rubber particle as a filler include butadiene rubber, acrylic rubber, silicone rubber, butyl rubber, olefin rubber, styrene rubber, NBR, SBR, IR and EPR. These may be used alone or two types or more of them are used in combination. The rubber particle as a filler is preferably a rubber particle containing at least one type of polymer selected from the group consisting of the polymers mentioned above. As an example, it is preferable that the rubber particle as a filler contains a rubber particle containing acrylic rubber and it is more preferable that the rubber particle is a rubber particle containing acrylic rubber. The rubber particle containing acrylic rubber is not particularly limited. Examples of the rubber particle containing acrylic rubber include a rubber particle having a core-shell structure and containing acrylic rubber. Note that, in the specification, the “acrylic rubber” refers to a (co) polymer having a constituent unit derived from an acrylic acid ester (acrylate) and/or a methacrylic acid ester (methacrylate) and is preferably a (co) polymer of an acrylate ester and/or a methacrylate ester.

The core-shell particle refers to a microparticle having a core (nucleus) part and a shell (wall) part of the particle, which are made of polymers with different properties, respectively. A preferable method for producing a core-shell particle (powder particle) to be used in the present invention is as follows: first, a polymerizable monomer constituting a core part is polymerized. Examples of the polymerizable monomer include (meth)acrylate-based monomers such as n-propyl (meth)acrylate, n-butyl (meth)acrylate, 2-ethylhexyl (meth)acrylate, n-decyl (meth)acrylate, 2-hydroxyethyl (meth)acrylate, 3-hydroxybutyl (meth)acrylate and 2-butoxyethyl (meth)acrylate; aromatic vinyl-based compounds such as styrene, vinyl toluene and α-methylstyrene; vinyl cyanide compounds such as acrylonitrile, methacrylonitrile, and vinylidene cyanide; 2-hydroxyethyl fumarate, hydroxybutyl vinyl ether, and monobutyl maleate. Furthermore, example of the polymerizable monomer include cross-linking monomers having 2 or more reactive groups such as ethylene glycol di(meth)acrylate, butylene glycol di(meth)acrylate, trimethylolpropane di(meth)acrylate, trimethylolpropane tri(meth)acrylate, hexanediol di(meth)acrylate, hexanediol tri(meth)acrylate, oligoethylene di(meth)acrylate, and oligoethylene tri(meth)acrylate; aromatic divinyl monomers such as divinylbenzene; triallyl trimellitate, and triallyl isocyanelate. One or two types or more of polymerizable monomers can be selected for use. Second, the polymer particles obtained using the polymerizable monomer exemplified above are used as the core, and the polymerizable monomer is polymerized so as to obtain a different composition from the core to form a shell made of a polymer having a melting point of room temperature or more in a second polymerization. The polymerizable monomer used in this step include the same polymerizable monomers as those for obtaining the core described above, and may be selected from these. Preferable examples of the polymerizable monomers to be used as the shell material include, (meth)acrylates having an alkyl group (alkyl group binding to a (meth)acryloyloxy group) having 1 to 4 carbon atoms, such as ethyl (meth)acrylate, n-butyl acrylate, methyl methacrylate and butyl methacrylate.

The core-shell particle may be synthesized, for example, by the above method, but a commercialized product may be used. Examples of the commercialized product of the core-shell particle that can be used include, but are not limited to PARALOID EXL-2655 (Dow Chemical Japan Co., Ltd.) made of a butadiene-alkyl methacrylate-styrene copolymer; core-shell particles made of an acrylate ester-methacrylate ester copolymer such as Staphyloid (registered trademark, the same applied hereinafter) AC-3355, Staphyloid AC3364, Staphyloid TR-2105, Staphyloid TR-2102, Staphyloid TR-2122, Staphyloid IM-101, Staphyloid IM-203, Staphyloid IM-301, Staphyloid IM-401, and Staphyloid IM-406; Staphyloid IM-601 made of an acrylate-acrylonitrile-styrene copolymer such as Staphyloid; core-shell particles made of a polymethacrylate ester-based polymer such as Zefiac (registered trademark) F-351G (manufactured by Aica Kogyo Co., Ltd.) and PARALOID EXL-2314, EXL-2611, and EXL-3387 (Dow Chemical Japan Co., Ltd.). These may be used alone or two types or more of them are used in combination. For the reason that an effect can be obtained in a small addition amount, a rubber particle as a filler preferably contains a (meth)acrylic core-shell particle containing at least one selected from the group consisting of an acrylate ester-methacrylate ester copolymer and a polymethacrylate ester-based polymer, more preferably contains a (meth)acrylic core-shell particle containing a polymethacrylate ester-based polymer, and it is particularly preferable that a rubber particle as a filler is a (meth)acrylic core-shell particle containing a polymethacrylate ester-based polymer.

An average particle diameter of a rubber particle is preferably 0.01 to 10 μm and particularly preferably 0.05 to 5 μm. When the average particle diameter is 0.01 μm or more, an increase in viscosity of a conductive paste can be suppressed, and when the average particle diameter is 10 μm or less, a conductive paste providing a cured product excellent in conductivity can be obtained. The average particle diameter of a rubber particle herein is the particle diameter (D50) at a cumulative volume ratio of 50% in the particle diameter distribution obtained by the laser diffraction/scattering method.

A content of a rubber particle is preferably 0.01 to 20 parts by mass, further preferably 0.05 to 10 parts by mass and particularly preferably 0.08 to 3 parts by mass, relative to 100 parts by mass of component (A). When the content of a rubber particle is 0.01 part by mass or more, conductivity of a cured product can be further improved, and when the content is 20 parts by mass or less, a conductive paste excellent in workability can be obtained. Note that, when two types or more rubber particles are used, the content of a rubber particle means the total content of them.

### (Storage Stabilizer)

The conductive paste according to the present invention may contain a storage stabilizer. The storage stabilizer is not particularly limited as long as it improves the storage stability of a conductive paste. A borate ester compound, phosphoric acid, an alkyl phosphate ester, p-toluenesulfonic acid or p-methyl toluenesulfonate may be blended. Examples of the borate ester compound include, trimethyl borate, triethyl borate, tri-n-propyl borate, triisopropyl borate, tributyl borate, trihexyl borate, tri-n-octyl borate, tris(2-ethylhexyloxy)borane, triphenylborate, trimethoxyboroxin, and 2,2′-carbonylbisoxybis-1,3,2-dioxaborolane-4,5-dione. Furthermore, examples of a commercialized product of a borate ester compound include “CUREDUCT L-07N” (manufactured by Shikoku Chemicals Corp.). Examples of the alkyl phosphate ester that can be used include, but are not limited to, trimethyl phosphate and tributyl phosphate. Storage stabilizers may be used singly or as a mixture. From the viewpoint of storage stability, a storage stabilizer preferably contains at least one selected from the group consisting of a phosphoric acid, a borate ester compound (e.g., tributyl borate, trimethoxyboroxin) and p-methyl toluenesulfonate, and more preferably contains a borate ester compound. Note that, a storage stabilizer dispersed in an epoxy resin or a phenol resin may be used. When a storage stabilizer dispersed in an epoxy resin is used as described above, the epoxy resin shall be included in the category of component (A).

The content of a storage stabilizer relative to 100 parts by mass of component (A) is preferably 0.01 to 10 parts by mass, further preferably 0.03 to 5 parts by mass, and particularly preferably 0.05 to 1 part by mass. If the content of a storage stabilizer is 0.01 part by mass or more, the effect of the storage stabilizer can be sufficiently obtained, whereas if the content is 10 parts by mass or less, a conductive paste excellent in workability can be obtained. Note that, when two types or more storage stabilizers are used, the content of a storage stabilizer means the total amount thereof.

### (Metal Complex)

The conductive paste according to the present invention may contain a metal complex. The metal complex is preferably an organometallic complex. Although a reason is still not clearly known, the conductive paste according to the present invention contains an organometallic complex, and thus contact resistance to an adherend containing nickel in the outermost surface is reduced. A metal (central metal) contained in the organometallic complex is preferably a divalent or trivalent metal. Examples of the metal include zinc, aluminum, iron, cobalt, nickel, tin and copper. By adding an organometallic complex having a divalent or trivalent metal as mentioned above, it is possible to obtain a conductive paste that has lower contact resistance to an adherend and is excellent in storage stability and handling, even when the adherend contains nickel in the outermost surface.

Furthermore, a ligand of an organometallic complex is not particularly limited but the ligand preferably includes an organic ligand having an alkoxy group and/or carboxylate group (—COO) and/or an amino group. Examples of the organic ligand include, but are not limited to, acetate, acetyl acetate (acetyl acetonate; acac), hexanoate, oleate, laurate and phthalocyaninate (phthalocyanine skeleton). By adding an organometallic complex having an organic ligand as mentioned above, it is possible to obtain a conductive paste that has lower contact resistance to an adherend and is excellent in storage stability and handling, even when the adherend contains nickel in the outermost surface.

Examples of the organometallic complex include, but are not limited to, copper oleate (divalent), zinc acetyl acetate (zinc acetyl acetonate) (divalent), aluminum acetyl acetate (aluminum acetyl acetonate) (trivalent), cobalt acetyl acetate (cobalt acetyl acetonate) (divalent), nickel acetate (divalent), nickel acetyl acetate (nickel acetyl acetonate) (divalent), iron phthalocyanine (divalent) and dibutyltin dilaurate (divalent). These may be used alone or two types or more of them are used in combination.

Either a synthetic product or a commercialized product may be used as the organometallic complex. Examples of organometallic complex commercially available include, but are not limited to, NACEM zinc (zinc acetyl acetonate (divalent)), NACEM aluminum (aluminum acetyl acetonate (trivalent)), NACEM cobalt (II) (cobalt acetyl acetonate (divalent)) and NACEM nickel (nickel acetyl acetonate (divalent)) manufactured by Nihon Kagaku Sangyo Co., Ltd; and KS-1260 (dibutyltin dilaurate (divalent)) manufactured by Kyodo Chemical Co., Ltd. These may be used alone or two types or more of them are used in combination.

When a conductive paste contains a metal complex (organometallic complex), a content of the metal complex (organometallic complex) is preferably 0.001 to 5% by mass, further preferably 0.01 to 3% by mass and particularly preferably 0.03 to 1% by mass, based on the total mass of the conductive paste regarded as 100% by mass. When the content of the above metal complex (organometallic complex) is 0.001% by mass or more, contact resistance can be further reduced, and when the content of the above metal complex (organometallic complex) is 5% by mass or less, satisfactory storage stability can be easily maintained. Note that, when two types or more metal complexes (organometallic complexes) are used, the content of metal complexes (organometallic complexes) means the total amount thereof.

### (Resin)

The conductive paste according to the present invention may contain a resin as an optional component (excluding component (A)). Examples of the resin include, but are not limited to, thermosetting resins such as a phenol resin (preferably Novolak-type phenol resin such as a phenol Novolak resin and cresol Novolak resin), a urea resin, a melamine resin, a (meth)acrylic resin, a vinyl ester resin, an unsaturated polyester resin, a bismaleimide resin and a polyurethane resin; and thermoplastic resins such as a polyethylene resin, a polypropylene resin, an ethylene-propylene copolymer, an ethylene-vinyl acetate copolymer, a polyvinyl chloride resin, a polystyrene resin, a polyacrylonitrile resin, a polyamide resin, a polycarbonate resin and, a thermoplastic urethane resin. The resins may be used singly or as a mixture. In particular, to obtain a conductive paste excellent in curability, the resin to be contained as an optional component is preferably a thermosetting resin, more preferably a phenol resin, and particularly preferably a Novolak-type phenol resin. When the conductive paste according to the present invention contains a phenol resin (preferably, a Novolak-type phenol resin) as an optional component, the storage stability thereof can be improved. When a storage stabilizer as an optional component is dispersed in a phenol resin, the phenol resin (preferably, Novolak-type phenol resin) should be included in the category of a resin as an optional component.

A content of a resin as an optional component is preferably 0.01 to 10 parts by mass, further preferably 0.03 to 5 parts by mass and particularly preferably 0.05 to 1 part by mass, relative to 100 parts by mass of component (A). Note that, when two types or more resins are used, the content of the resins means the total amount thereof.

In a preferable embodiment, the conductive paste according to the present invention is substantially composed of components (A) to (C) and at least one selected from the group consisting of component (D), a silane coupling agent, a filler, a storage stabilizer, a metal complex and a resin (excluding component (A), the same applies hereinafter). In a preferable embodiment, the conductive paste according to the present invention is substantially composed of components (A) to (D) and at least one selected from the group consisting of a silane coupling agent, a filler, a storage stabilizer, a metal complex and a resin. In a preferable embodiment, the conductive paste according to the present invention is substantially composed of components (A) to (D) and at least one selected from the group consisting of a filler, a storage stabilizer, a metal complex and a resin. In a preferable embodiment, the conductive paste according to the present invention is substantially composed of components (A) to (D) and at least two selected from the group consisting of a filler, a storage stabilizer, a metal complex and a resin. In a preferable embodiment, the conductive paste according to the present invention is substantially composed of components (A) to (D) and at least one selected from the group consisting of a filler, a storage stabilizer and a resin. In a preferable embodiment, the conductive paste according to the present invention is substantially composed of components (A) to (D), a filler and a storage stabilizer. In a preferable embodiment, the conductive paste according to the present invention is substantially composed of components (A) to (D), a filler, a storage stabilizer and a resin.

In the above embodiments, the phrase “the conductive paste is substantially composed of X” means that the total content of X exceeds 99% by mass (upper limit: 100% by mass) relative to the total mass of the conductive paste regarded as 100% by mass (relative to the conductive paste). Preferably, the conductive paste composed of X (the above total content=100% by mass). For example, “the conductive paste according to the present invention is substantially composed of components (A) to (C) and at least one selected from the group consisting of component (D), a silane coupling agent, a filler, a storage stabilizer, a metal complex and a resin” means that the total content (total addition amount) of components (A) to (D), a silane coupling agent, a filler, a storage stabilizer, a metal complex and a resin exceeds 99% by mass (upper limit: 100% by mass) relative to the total mass of the conductive paste regarded as 100% by mass (relative to the conductive paste), and the conductive paste is preferably composed of components (A) to (C), and at least one selected from the group consisting of component (D), a silane coupling agent, a filler, a storage stabilizer and a metal complex (the above total content=100% by mass). “The conductive paste according to the present invention is substantially composed of components (A) to (D), and at least one selected from the group consisting of a silane coupling agent, a filler, a storage stabilizer, a metal complex and a resin” means that the total content (total addition amount) of components (A) to (D), a silane coupling agent, a filler, a storage stabilizer, a metal complex and a resin exceeds 99% by mass (upper limit: 100% by mass) relative to the total mass of the conductive paste regarded as 100% by mass (relative to the conductive paste), and the conductive paste is preferably composed of components (A) to (D), and at least one selected from the group consisting of a silane coupling agent, a filler, a storage stabilizer, a metal complex and a resin (the above total content=100% by mass). “The conductive paste according to the present invention is substantially composed of components (A) to (D) and at least one selected from the group consisting of a filler, a storage stabilizer, a metal complex and a resin” means that the total content (total addition amount) of components (A) to (D), a filler, a storage stabilizer, a metal complex and a resin exceeds 99% by mass (upper limit: 100% by mass) relative to the total mass of the conductive paste regarded as 100% by mass (relative to the conductive paste), and the conductive paste is preferably composed of components (A) to (D), and at least one selected from the group consisting of a filler, a storage stabilizer, a metal complex and a resin (the above total content=100% by mass). “The conductive paste according to the present invention is substantially composed of components (A) to (D), and at least two selected from the group consisting of a filler, a storage stabilizer, a metal complex and a resin” means that the total content (total addition amount) of components (A) to (D), a filler, a storage stabilizer, a metal complex and a resin exceeds 99% by mass (upper limit: 100% by mass) relative to the total mass of the conductive paste regarded as 100% by mass (relative to the conductive paste), and the conductive paste is preferably composed of components (A) to (D), and at least two selected from the group consisting of a filler, a storage stabilizer, a metal complex and a resin (the above total content=100% by mass). “The conductive paste according to the present invention is substantially composed of components (A) to (D), and at least one selected from the group consisting of a filler, a storage stabilizer, and a resin” means that the total content (total addition amount) of components (A) to (D), a filler, a storage stabilizer and a resin exceeds 99% by mass (upper limit: 100% by mass) relative to the total mass of the conductive paste regarded as 100% by mass (relative to the conductive paste), and the conductive paste is preferably composed of components (A) to (D), and at least one selected from the group consisting of a filler, a storage stabilizer, and a resin (the above total content=100% by mass). “The conductive paste according to the present invention is substantially composed of components (A) to (D), a filler and a storage stabilizer” means that the total content (total addition amount) of components (A) to (D), a filler and a storage stabilizer exceeds 99% by mass (upper limit: 100% by mass) relative to the total mass of the conductive paste regarded as 100% by mass (relative to the conductive paste), and the conductive paste is preferably composed of components (A) to (D), a filler and a storage stabilizer (the above total content=100% by mass). “The conductive paste according to the present invention is substantially composed of components (A) to (D), a filler, a storage stabilizer and a resin” means that the total content (total addition amount) of components (A) to (D), a filler, a storage stabilizer and a resin exceeds 99% by mass (upper limit: 100% by mass) relative to the total mass of the conductive paste regarded as 100% by mass (relative to the conductive paste), and the conductive paste is preferably composed of components (A) to (D), a filler, a storage stabilizer and a resin (the above total content=100% by mass).

### [Curing Method and Cured Product]

The conductive paste according to the present invention can be cured by heating, and can be cured even at a low temperature (less than 100° C.). Accordingly, another aspect of the present invention can provide a cured product of the above conductive paste (cured conductive paste).

A method for producing a cured product (method for curing a conductive paste) is not particularly limited and a commonly known method can be used. For example, there is a method for producing a cured product by applying the conductive paste according to the present invention to an adherend, followed by heating. To improve workability during the application, the conductive paste according to the present invention is preferably liquid (liquid state). For example, a viscosity of a conductive paste at 25° C. is preferably 0.01 Pa·s or more and less than 1000 Pa·s, more preferably 0.1 to 500 Pa·s, further preferably 0.3 to 100 Pa·s, particularly preferably 0.5 to 50 Pa·s, and most preferably 1 to 20 Pa·s. Note that, in the specification, the viscosity of a conductive paste is a viscosity measured at 25° C. using a cone-plate type rotational viscometer at a shear rate of 10 s⁻¹.

When a conductive paste is applied, a thickness of a coating film is not particularly limited and appropriately controlled within the range that enables adhesion to an adherend. Furthermore, heating conditions (curing conditions) are not particularly limited as long as a conductive paste can be sufficiently cured. For example, among the heating conditions for the method for curing a conductive paste according to the present invention, a heat-curing temperature is not particularly limited, but from the viewpoint of minimizing damage to a member as an adherend, the temperature is preferably 45 to 100° C., and more preferably 50 to 95° C. A time for heat curing is not particularly limited, but in the case of heat-curing temperature of 45 to 100° C., the time for heat curing is preferably 10 minutes to 3 hours, and further preferably 30 minutes to 2 hours, for the reason that the production efficiency by the production method using the conductive paste.

### [Adherend]

The conductive paste according to the present invention and a cured product thereof can be used for electronic components or the like requiring conductivity. The conductive paste according to the present invention and a cured product thereof are excellent in conductivity and adhesive strength, and therefore can be suitably used for an adherend having outermost surface formed of nickel, which has poor conductivity. The adherend having outermost surface formed of nickel is not particularly limited, and is mainly one that is plated with nickel, for example, members formed of SPCC (cold-rolled steel sheet), stainless steel or copper that have been electrolytically or electrolessly plated (e.g., electric wire, a printed circuit board).

### EXAMPLES

Now, the present invention will be explained in more detail with reference to the following examples, but the present invention it not limited to these examples. Furthermore, unless otherwise specified, operations and tests were carried out in an environment of 25° C. and 55% RH. Note that, “concentration” and “%” represent mass concentration and % by mass, respectively, unless otherwise specified and “ratio” is a mass ratio unless otherwise specified.

### Examples 1 to 3 and Comparative Examples 1 to 4

For preparing conductive pastes, the following components were prepared. Hereinafter, a conductive paste will be sometimes referred to simply as a “composition”. Note that, viscosity of each component shown below is the value measured at a shear rate of 10 s⁻¹ using a cone-plate type rotational viscometer in an environment of 25° C. and 55% RH.

### Component (A): Epoxy Resin

EPICLON (registered trademark) EXA-835LV (a mixture of a bifunctional bisphenol A type epoxy resin and a bifunctional bisphenol F type epoxy resin, a mass ratio of 50:50, epoxy equivalent: 165 g/eq, viscosity (25° C.): 2000 mPa·s (2 Pa·s) manufactured by DIC CORPORATION)·
CARDURA (registered trademark) E10P (neodecanoic acid glycidyl ester (monofunctional epoxy resin), epoxy equivalent: 240 g/eq, viscosity (25° C.): 7 mPa·s, monofunctional epoxy resin, manufactured by MOMENTIVE)

### Component (B): Latent Curing Agent

Fujicure (registered trademark) FXR-1081 (modified aliphatic polyamine latent curing agent (urea adduct-type modified aliphatic polyamine latent curing agent), average particle diameter: 5 μm, manufactured by T&K TOKA Corporation)
Component (C): crystalline metal powder having an average particle diameter of 0.6 to 1.4 μm
LM1 (single crystal silver particle plate-shaped, surface treated with stearic acid, average particle diameter (D50): 1.0 μm, average thickness (T): 60 nm, aspect ratio (D50/T): 16.7, specific surface area: 1.0 m²/g manufactured by Tokusen Kogyo Co., Ltd.)

### Component (C)′: Crystalline Metal Powder Except for Component (C)

N300 (single crystal, silver particle, plate-shaped, surface treated with stearic acid, average particle diameter (D50): 0.4 Ulm, average thickness (T): 40 nm, aspect ratio (D50/T): 10, specific surface area: 2.4 m²/g, manufactured by Tokusen Kogyo Co., Ltd.)
M13 (single crystal, silver particle, plate-shaped, surface treated with stearic acid, average particle diameter (D50): 2.0 μm, average thickness (T): 50 nm, aspect ratio (D50/T): 40, specific surface area: 1.1 m²/g manufactured by Tokusen Kogyo Co., Ltd.)
M27 (single crystal, silver particle, plate-shaped, surface treated with stearic acid, average particle diameter (D50): 4.5 μm, average thickness (T): 80 nm, aspect ratio (D50/T): 56.3, specific surface area: 1.0 m²/g manufactured by Tokusen Kogyo Co., Ltd.)

### Component (D): Metal Powder Except for Component (C)

Silbest TC-770 (flake-shaped silver particles (non-crystalline) surface treated with stearic acid, average particle diameter (D50): 3.5 μm, manufactured by Tokuriki Honten Co., Ltd.)
Silver-coated powder general-purpose type (core agent: acrylic resin (20% by mass), coating: silver (80% by mass) perfectly spherical, average particle diameter (D50): 2 μm, manufactured by Mitsubishi Materials Corporation)

### Optional Components

Zefiac F-351G (filler, polymethacrylate ester-based core-shell particles, average particle diameter: 0.3 μm, manufactured by Aica Kogyo Co., Ltd.)
CUREDUCT (registered trademark) L-07N (storage stabilizer, epoxy-phenol-borate ester blends (containing a bifunctional bisphenol A type epoxy resin: 91% by mass, a phenol Novolak resin: 4% by mass, a 2,2′-(carbonylbisoxy)bis(1,3,2-dioxaborolane-4,5-dione: 5% by mass) manufactured by Shikoku Chemicals Corp.)

A method for producing each of the compositions according to Examples 1 to 3 and Comparative Examples 1 to 4 is as follows. Component (A), component (C) (or component (C)′), component (D) and an optional component(s) were weighed, and stirred by a planetary mixer for 30 minutes. Subsequently, component (B) was weighed and added. Stirring was performed by a planetary mixer further for 30 minutes while degassing in vacuum to obtain a conductive paste. The obtained conductive pastes were all in a liquid state at 25° C. Specific contents (addition amount of each component) are shown in Table 1 and the units of the numerical values are all parts by mass. Note that, a blank column means that the corresponding component was not added (addition amount: 0 parts by mass).

### <Conductivity Measurement>

In a masking tape having a width of 10 mm and a thickness of 100 μm, 5 holes of 5 mm diameter were formed along the length direction at intervals of 10 mm. The masking tape was attached onto an electroless nickel-plated plate having a width of 25 mm×a length of 100 mm×a thickness of 1.6 mm, and each of the compositions was applied onto the masking tape by use of a squeegee. During application by a squeegee, care was taken so as not to produce foams in the composition. Subsequently, the masking tape was removed, and the composition was cured by heating at 80° C. for 60 minutes in a hot-air drying furnace. After temperature of test pieces decreased to room temperature, needle-like electrodes of a dual display multimeter were allowed to touch to adjacent cured products (2 cured products formed at an interval of 10 mm) of the composition, respectively, to measure a resistance value. The obtained resistance values were listed in the column of “conductivity (Ω)” in Table 1. By such measurement, the resistance value (volume resistivity) of a cured product (conductive paste) itself, the resistance value (contact resistance value) generated between the cured product (conductive paste) and the electroless nickel-plated plate, and the resistance value (volume resistivity) of the nickel-plated plate itself can be measured simultaneously in combination. The value of “conductivity (δ)” is preferably 0.30Ω or less, and more preferably 0.20Ω or less (lower limit: 0.01Ω).

### <Measurement of Adhesive Strength>

Onto an electroless nickel-plated plate having a thickness of 1.6 mm×a width of 25 mm×a length of 100 mm, a masking tape was attached so as to have a width of 5 mm×a thickness of 50 μm. Onto the nickel-plated plate having the masking tape adhered, each of the compositions was applied by use of a squeegee to form a uniform coating, and then the masking tape was removed. A ceramic chip of 2φ×1 mm was dropped on the coating vertically at a distance of 1 cm above the coating to form a test piece (n=5). The test pieces were cured by heating at 80° C. for 60 minutes in a hot-air drying furnace. After the temperature of the test pieces decreased to room temperature, a digital force gauge with a contact maker was moved at a rate of 50 mm/minute while a nickel-plated plate was fixed, the contact maker pushed the chip vertically to the long side of the test piece to measure a “maximum strength (N)”. An “adhesion strength (MPa)” was calculated by conversion from the adhesive area and evaluated the following evaluation criteria. To keep the adherend not to fall, the adhesion strength is preferably 20 MPa or more, and more preferably 25 MPa or more (upper limit: 50 MPa).

TABLE 1

| | | | | | Comparative | Comparative | Comparative | Comparative |
|---|---|---|---|---|---|---|---|---|
| Raw material | | Example 1 | Example 2 | Example 3 | Example 1 | Example 2 | Example 3 | Example 4 |
| Component (A) | EPICLON EXA-83SLV | 80 | 80 | 80 | 80 | 80 | 80 | 80 |
| | CARDURA E10P | 20 | 20 | 20 | 20 | 20 | 20 | 20 |
| | CUREDUCT L-07N | 1.8 | 1.8 | 1.8 | 1.8 | 1.8 | 1.8 | 1.8 |
| | (bisphenol A type epoxy | | | | | | | |
| | resin) | | | | | | | |
| Component (B) | Fujicure FXR-1081 | 20 | 20 | 20 | 20 | 20 | 20 | 20 |
| Component (C) | LM1 (D50:1.0 μm) | 40 | 60 | 80 | | | | |
| Component (C)′ | N300 (D50:0.4 μm) | | | | | 40 | | |
| | M13 (D50:2.0 μm) | | | | | | 40 | |
| | M27 (D50:4.5 μm) | | | | | | | 40 |
| Component (D) | Silbest TC-770 | 120 | 100 | 80 | 160 | 120 | 120 | 120 |
| | (D50:3.5 μm) | | | | | | | |
| | Silver coat powder, | 70 | 70 | 70 | 70 | 70 | 70 | 70 |
| | general-purpose type | | | | | | | |
| | (D50:2 (μm) | | | | | | | |
| Optional | Zefiac F-351G | 0.1 | 0.1 | 0.1 | 0.1 | 0.1 | 0.1 | 0.1 |
| component | CUREDUCT L-07N | 0.1 | 0.1 | 0.1 | 0.1 | 0.1 | 0.1 | 0.1 |
| | (borate ester compound) | | | | | | | |
| | CUREDUCT L-07N | 0.1 | 0.1 | 0.1 | 0.1 | 0.1 | 0.1 | 0.1 |
| | (phenol Novolak resin) | | | | | | | |

| | | | | | | | |
|---|---|---|---|---|---|---|---|
| Conductivity (Ω) | 0.25 | 0.15 | 0.15 | 2.5 | 0.45 | 0.35 | 0.40 |
| Adhesive strength (MPa) | 22 | 25 | 26 | 18 | 23 | 22 | 20 |

Examples 1 to 3 are compositions each containing components (A) to (C) and all of them were confirmed to have excellent conductivity and adhesive strength. In contrast, Comparative Example 1, which is a composition not containing component (C), was inferior in conductivity and adhesive strength. Comparative Examples 2 to 4, which are compositions containing component (C)′ with different property instead of component (C), were excellent in adhesive strength but inferior in conductivity.

### INDUSTRIAL APPLICABILITY

Since the conductive paste of the present invention and a cured product thereof are excellent in conductivity and adhesive strength, they are useful for electrical conduction/adhesive applications for miniaturized electric/electronic components in recent years, in particular, can reduce resistance value to a metal such as nickel, which tends to exhibit poor conductivity. Because of these properties, the present invention can be used for the assembly of various electric/electronic components and a wide variety of applications may be developed.

This application is based on Japanese Patent Application No. 2022-067363 filed on Apr. 15, 2022 and the content of the disclosure thereof is incorporated herein in its entirety by reference.

1. A conductive paste comprising the following components (A) to (C):
component (A): an epoxy resin;
component (B): a latent curing agent; and
component (C): a plate-like crystalline metal powder having an average particle diameter of 0.6 to 1.4 μm.

2. The conductive paste according to claim 1, wherein a content of the component (C) is 20 to 300 parts by mass relative to 100 parts by mass of the component (A).

3. The conductive paste according to claim 1, wherein the component (C) has a specific surface area of 0.1 to 1.8 m²/g.

4. The conductive paste according to claim 1, further comprising a metal powder other than the component (C) as component (D).

5. The conductive paste according to claim 4, wherein a content of the component (D) is 50 to 500 parts by mass relative to 100 parts by mass of component (A).

6. The conductive paste according to claim 1, wherein the component (A) contains a monofunctional epoxy resin.

7. The conductive paste according to claim 1, further comprising a rubber particle.

8. A cured product of the conductive paste set forth in claim 1.
